(19) United States
(12) Patent Application Publication
(10) Pub. No.: US 2009/0005983 A1
(43) Pub. Date: Jan. 1, 2009

(54) PERSONAL GUIDE APPLICATION

(75) Inventor: Anders MARDELL, Sollentuna (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 11/770,857

(22) Filed: Jun. 29, 2007

(51) Int. Cl. G01C 21/00

(52) U.S. Cl. 701/213; 701/207

(57) ABSTRACT

Device, system, method and computer program for navigation assistance where the device receives location information related to at least one of its geographical locations, calculates the at least one geographical location of the device from the received location information, registers visual and/or sound data related to its at least one calculated geographical location. The device for navigation assistance further associates the at least one calculated geographical location with the registered visual and/or sound data in the form of a guided tour from its initial geographical location to a final geographical location and stores the guided tour in the form of a file onto a memory in the device for navigation assistance.

### TECHNICAL FIELD

Embodiments disclosed herein may relate to the field of personal navigation.

### BACKGROUND

Today, position determination making use of the GPS (Global Positioning System) has become the most widely spread positioning technology. In the most common GPS system, the position of an object on the surface of the earth may be determined by sending timing and orbital coordinates from, for example, three satellites (in one embodiment geostationary satellites) to a GPS receiver. By correcting the clock of the GPS receiver using clock synchronization signals from the three satellites plus a clock error correction signal from a fourth satellite (in one embodiment a fourth geostationary satellite), the position of an object may be determined with high accuracy.

This may also true for moving objects, such as motor vehicles, boats, aircraft or even people using a GPS receiver.

A variety of GPS navigation equipment exists on the market today, from simple hand-held GPS receivers displaying coordinates and direction of movement to more advanced ones equipped with maps of entire regions with streets, roads, freeways, hotels and points of interest. The latter category has found application in motor vehicles as a built-in GPS navigation system or as a separate GPS navigation device. However, such GPS navigation devices more and more also find application on motorcycles, bicycles or as mobile GPS navigation devices.

For a number of years, PDAs (Personal Digital Assistants) and so called smartphones equipped with GPS navigation software and GPS receiver have been in use. In these systems the position of the user of the GPS navigation device may be determined by triangulation and by mapping geographical coordinates of the GPS navigation device to an available street or geographical map.

GPS navigation devices of today may provide the user with navigation along the shortest route or the fastest route. In the case of GPS navigation devices used in motor vehicles the best route may also be calculated taking the fuel consumption into account.

### SUMMARY

One aspect of one embodiment may be directed towards a device for navigation assistance and may comprise: at least one receiver for receiving location information related to at least one geographical location of the device; an image or sound acquisition unit for registering visual or audio comments related to the at least one geographical location of the device; a memory for storing the registered visual or audio comments related to the at least one geographical location of the device and; and a processing unit for calculating the at least one geographical location of the device from the received location information, wherein the processing unit is arranged to associate the at least one geographical location of the device with one or more registered visual or audio comments in the form of a guided tour from an initial geographical location of the device to a final geographical location of the device and to store the guided tour as a file onto the memory for later retrieval.

In this fashion, a user of the device for navigation assistance may design his own routes which may not necessarily be based on low fuel consumption or the shortest distance, but rather on points of interest. Another advantage is the possibility to share a the recorded guided tour with other users operating similar devices for navigation assistance giving them opportunity to enjoy a customized and feature reach guided tour.

Another aspect of one embodiment may be directed towards a method for navigation assistance and may include: a) receiving location information related to at least one geographical location of a device for navigation assistance; b) calculating the at least one geographical location of the device from the received location information; c) registering visual and/or sound data related to the at least one calculated geographical location of the device; d) associating the at least one calculated geographical location with the registered visual and/or sound data in the form of a guided tour from an initial geographical location of the device to a final geographical location of the device and; e) storing the guided tour in the form of a file onto a memory in the device for navigation assistance.

The method according to one embodiment may be suited to be executed by the device for navigation assistance described earlier.

Yet another aspect of one embodiment may be related to a computer program for navigation assistance and may include instruction sets for: a) receiving location information related to at least one geographical location of a device for navigation assistance; b) calculating the at least one geographical location of device from the received location information; c) registering visual and/or sound data related to the at least one calculated geographical location of the device; and d) associating the at least one calculated geographical location with the registered visual and/or sound data in the form of a guided tour from an initial geographical location of the device to a final geographical location of the device; e) storing the guided tour in the form of a file onto a memory in the device for navigation assistance.

The computer program according to one embodiment may be suitable for implementing the method described earlier.

One other aspect of one embodiment may be related to a system for navigation assistance and may include: at least one receiver for receiving location information related to at least one geographical location of the device; an image or sound acquisition unit for registering visual or audio comments related to the at least one geographical location of the device; a memory for storing the registered visual or audio comments related to the at least one geographical location of the device and a processing unit for calculating the at least one geographical location of the device from the received location information, wherein the processing unit is arranged to associate the at least one geographical location of the device with one or more registered visual or audio comments in the form of a guided tour from an initial geographical location of the device to a final geographical location of the device and to store the guided tour as a file onto the memory for later retrieval wherein the system may further include a transmitter for transmitting the stored file to another device for navigation assistance.

The device for navigation assistance described earlier may be suited for operating in a system described above.

### BRIEF DESCRIPTION OF THE DRAWINGS

FIG. 1 illustrates an exemplary navigation device according to one embodiment.

FIG. 2 illustrates an exemplary process according to one embodiment.

### DETAILED DESCRIPTION OF PREFERRED EMBODIMENTS

Embodiments disclosed herein may provide a more flexible and personal way of using a personal navigation device, where the device may provide the user with a capability to more flexibly define his route. Embodiments disclosed herein may allow a user to personalize the route according to his or her wishes. For example, embodiments disclosed herein may allow for personalization of a route from a starting to a destination point.

The components of the mobile terminal 100 may include a receiver/transmitter combination 110 in communication with a processing unit 150, furthermore an image acquisition unit 120, such as a digital camera, a visual output unit 130 in connection with the image acquisition unit 120 and the processing unit 150, a user interface 140 in communication with both the visual output unit 130 and the processing unit 150.

Apart from these components, the mobile terminal 100 also may include a sound acquisition unit 160, such as a microphone, in communication with the processing unit 150, a sound output unit 170 and a memory 180—both connected to the processing unit 150.

Now, the processing unit 150 may via the receiver/transmitter combination 110 register satellite coordinates of at least three, for example, satellites plus receive timing data related to the clock onboard the satellites. In one embodiment the satellites are geostationary satellites. Using these two parameters the processing unit may be able to determine the geographical coordinates of the mobile terminal 100 as well as it's velocity of movement. Since the detailed procedure of calculating geographical coordinates from satellite coordinates is known to the skilled person, it will not be elaborated further here.

However, the processing unit 150 may also determine the geographical coordinates of the mobile terminal via methods other than satellite navigation, such as triangulation using RSSI (Received Signal Strength Indicator) for signals received from the receiver/transmitter combination 110 or some other known positioning technology. It should be remarked that in this case, the navigation device may be provided with a receiver/transmitter combination 110 adapted to function in a wireless communication network and to receive signals from at least three base station transceivers closest to the navigation device. Also other methods of positioning in a wireless communication network are possible.

The processing unit 150, when recording the tour, either may use a computer program stored on an ASIC (Application Specific Integrated Circuit), or a computer program stored in the memory 180 of the navigation device 100. However, in another variant of the navigation device 100, the computer program for recording the guided tour may also be a downloadable computer program from, for example, a server in a communication network with which the navigation device 100 may be in communication.

Thus, the geographical coordinates of a user using the mobile terminal 100 wishing to record a so called “guided tour” may be known at the start of the tour.

The mobile terminal 100 may also include image and sound acquisition units 120 and 160, such as, for example, a digital camera and a microphone via which the user of the mobile terminal 100 may be able to take photographs and possible video sequences as well as record sounds or music and save them in the memory 180. Thus, the user may be able to add specific video clips and images via the image acquisition device, which, for example, may be a digital camera and/or a video camera of the guided tour. These specific images or video clips may show interesting sites along the tour and also explain a specific item of interest more in detail. Also, the audio acquisition unit 160 may enable the user to record specific comments to the guided tour he wished to record, making the guided tour more personalized than in the case of navigation devices using known technology. The processing unit 150 may relate these recorded images or videos and sounds to the geographical coordinates of the navigation device 100 and may also store them in the memory 180. In this fashion the guided tour may be provided with customized images or video clips and spoken commentary, sounds or music, making the guided tour more interesting to printed tour guides or the capabilities of existing navigation devices on the market.

The memory may be any type of storage suitable for storing geographical coordinates, images, video, sound, music and other data, such as the recorded guided tour. Thus the memory 180 in the navigation device 100 may comprise a RAM (Random Access Memory), a FlashROM (Flash Read Only Memory), a hard-disk, a memory card and other storage facilities.

Via the user interface 140 a user of the navigation device 100 may start and stop the recording of the personalized tour, activate the video and audio acquisition devices 120 and also replay the entire recorded tour, if desired.

In case the receiver/transmitter combination 110 of the navigation device 100 may also be adapted to receive data and control signals from a wireless communication network, such as from a GSM (Global System for Mobile telephony), UMTS (Universal Mobile Telecommunication System), IEEE 802.11 (a, b, g, and n) series wireless network, WiMax, HyperLAN and other wireless communication networks, then the user interface 140 may be adapted for using services known from these wireless communication networks.

It may be added that the recorded guided tour may be chosen to be stored into the memory 180 of the navigation device 100 and/or transmitter via the receiver/transmitter combination 110 to a place in the communication network, such as a server. Alternatively, the recorded guided tour may be directly transferred to another navigation device, which may only be equipped with a receiver.

The uploading of the recorded guided tour onto a server may allow the tour to be available in a central location for easy download onto any suitable navigation device able to read the format in which the file containing the recorded guided tour may be saved. Thus, for instance, when using a bicycle, a motorcycle, a car or even walking, the guided tour may be readily available after download from a server in the communication network. The second alternative may allow for sharing of a personal guided tour with users familiar with the user who recorded the guided tour. Also, the recorded guided tour may be stored onto a memory card, as stated earlier and easily plugged into another navigation device.

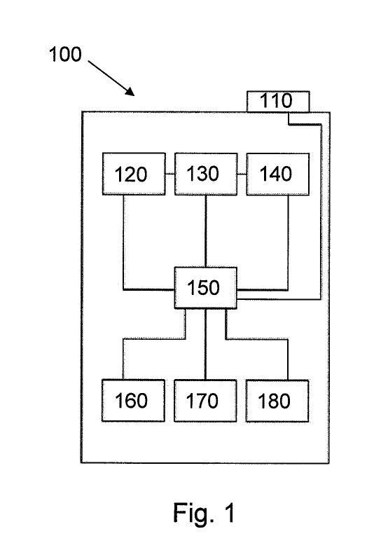

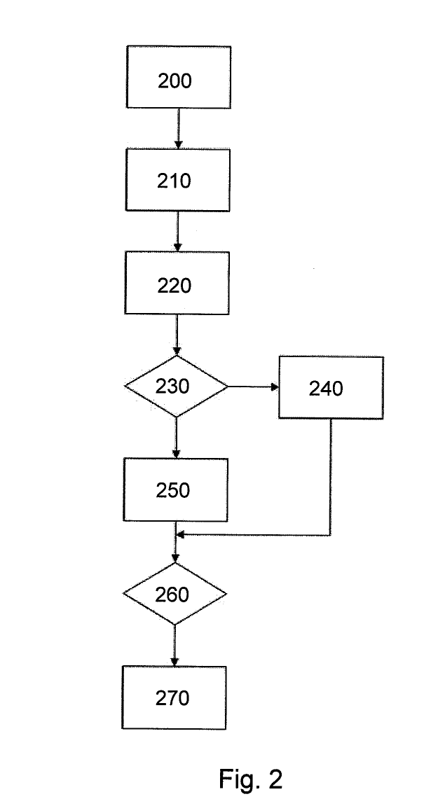

Turning now to FIG. 2 a process according to one embodiment is shown. At block 200, a user of a navigation device, such as the navigation device 100 from FIG. 1 may start the recording of a personal guided tour by operating the user interface of the navigation device, such as the user interface 140 in FIG. 1. At that instant the navigation device may, for example, receive coordinates (in one embodiment geostationary coordinates) from at least three, for example, satellites and by means of a processing unit, such as the processing unit 150 in FIG. 1 convert them into geographical coordinates of the navigation device. In one embodiment, the satellites may be geostationary satellites. Thus, the geographical coordinates of the navigation device may be known at the moment when the user starts the recording. As mentioned earlier, the geographical coordinates for the navigation device may be determined by methods other than triangulation from coordinates (in one embodiment geostationary coordinates), such as triangulation in a wireless communication network involving, by way of example, determination of the RSSI from at least three base stations in the wireless communication network.

At block 210, new current geographical coordinates for the navigation device may be determined. If satellite navigation via GPS (Global Positioning System), GLONASS or Galileo for example are used, then a comparison between the internal clock of the navigation device and the data containing the time stamps from the three or more satellites can be used to determine the velocity of movement for the navigation device and thus. The movement of the user may also be recorded on a geographical map of the area through which the user is moving, whereby the geographical map may be pre-stored in the memory of the navigation device. If at block 230 it is detected that the user of the navigation device has recorded commenting data to the personal guided tour, such as spoken comments, sounds, music, images or video clips of the scenery near the area through which he is moving or a combination of these comments, the geographical coordinates of the navigation device may be stored at block 250 together with the comments in a file in the memory of the navigation device. Thus, the navigation device may be adapted to add data and comments to the “guided tour file” at the moment they are added. If no recording of comments is detected at block 230, the navigation device may continue with calculating its most current geographical coordinates at block 240.

The navigation device need not wait for the user to add comments to a guided tour during a recording but simply register when a comment has been added by the user. This check of whether comments have been added or not may be performed at predefined time intervals or intermittently.

At block 260 the navigation device may check whether it has received any stop-command from the user performing the recording of the guided tour. If such a stop-command has been registered the navigation device may stop the recording of the guided tour. Otherwise, the navigation device continues with calculating its most current geographical coordinates.

One should bear in mind that the calculation of the most current coordinates need not be carried out continuously, but may be performed at regular timer intervals or intermittently, as desired.

For example, if it is desirable to take a route which not necessarily is the fastest or the shortest, but interesting from a sightseeing or historical point of view, the existing navigation devices offer little help. Also other criteria, such as interesting shopping areas, restaurants and other points of interest are covered only in a very schematic way by existing technology.

By means of the method according to one embodiment, a navigation through a city, or a geographical area of interest may be designed to be much more informative and entertaining while at the same time providing the user with a better connection between the maps seen on the display of the navigation device and the real world around him than the known navigation provided by, for example, GPS-receivers offering few choices as far as customization of the tour is concerned. Thus routes which are not meant to be the shortest or fastest, but rather interesting from a sightseeing or a historical point of view may be followed by the user. Also other customized tours may be undertaken, such as tours involving interesting shopping areas, restaurants and other points of interest.

These customized directions may be provided for pedestrians, cyclists, motor vehicle drivers and others.

For a skilled person who has read the description various other variants of the present invention will be possible and therefore the scope of the invention is only limited by accompanying patent claims.

1. A system for navigation assistance comprising:
at least one receiver for receiving location information related to at least one geographical location of a device;
an image or sound acquisition unit for registering visual or audio comments related to the at least one geographical location of the device;
a memory for storing the registered visual or audio comments related to the at least one geographical location of the device; and
a processing unit for calculating the at least one geographical location of the device from the received location information, wherein the processing unit is arranged to associate the at least one geographical location of the device with one or more registered visual or audio comments in the form of a guided tour from an initial geographical location of the device to a final geographical location of the device and to store the guided tour as a file onto the memory for later retrieval.

2. The system according to claim 1, wherein the device further comprises a transmitter for transmitting the stored file to another device for navigation assistance.

3. The system according to claim 2, wherein the transmitter is further adapted for transmission of the stored file to a node in a communication network.

4. The system according to claim 1, wherein the device further comprises a user interface for activating the registering of visual or audio comments related to the at least one geographical location of the device.

5. The system according to claim 4, wherein the device further comprises a visual and an audio output unit for outputting the registered visual and audio comments related to the at least one geographical location of the device.

6. The system according to claim 5, wherein the device comprises a mobile terminal for communication in a wireless communication network, such as a GSM (Global System for Mobile telephony), a UMTS (Universal Mobile Telecommunication System), a IEEE 802.11 (a, b, g, n) series network, a WiMax, HyperLAN or other suitable wireless communication network.

7. The system according to claim 1, wherein the location information comprises coordinates from at least three satellites.

8. A method for navigation assistance comprising:
receiving location information related to at least one geographical location of a device for navigation assistance;
calculating the at least one geographical location of the device from the received location information;
registering visual and/or sound data related to the at least one calculated geographical location of the device;
associating the at least one calculated geographical location with the registered visual and/or sound data in the form of a guided tour from an initial geographical location of the device to a final geographical location of the device; and
storing the guided tour in the form of a file onto a memory in the device for navigation assistance.

9. The method according to claim 8, further comprising transmitting the stored file to another device for navigation assistance.

10. The method according to claim 9, further comprising transmitting the stored file to a node in a communication network.

11. The method according to claim 8, further comprising activating the registering of visual or audio comments related to the at least one geographical location of the device.

12. The method according to claim 11, further comprising outputting the registered visual and audio comments related to the at least one geographical location of the device.

13. The method according to one of the claims 8, further comprising receiving coordinates from at least three satellites.

14. A computer-readable medium including instructions to perform a method by a processor, the method comprising:
receiving location information related to at least one geographical location of a device for navigation assistance;
calculating the at least one geographical location of device from the received location information;
registering visual and/or sound data related to the at least one calculated geographical location of the device;
associating the at least one calculated geographical location with the registered visual and/or sound data in the form of a guided tour from an initial geographical location of the device to a final geographical location of the device; and
storing the guided tour in the form of a file onto a memory in the device for navigation assistance.

15. The method according to claim 14, further comprising transmitting the stored file to another device for navigation assistance.

16. The method according to claim 15, further comprising transmitting the stored file to a node in a communication network, such as a server.

17. The method according to one of the claims 14, further comprising activating the registering of visual or audio comments related to the at least one geographical location of the device.

18. The method according to one of the claims 17, further comprising outputting the registered visual and audio comments related to the at least one geographical location of the device.

19. The method according to one of the claims 14, further comprising receiving coordinates from at least three satellites.

20. A device for navigation assistance comprising:
at least one receiver for receiving location information related to at least one geographical location of the device;
an image or sound acquisition unit for registering visual or audio comments related to the at least one geographical location of the device;
a memory for storing the registered visual or audio comments related to the at least one geographical location of the device; and
a processing unit for calculating the at least one geographical location of the device from the received location information, wherein the processing unit is arranged to associate the at least one geographical location of the device with one or more registered visual or audio comments in the form of a guided tour from an initial geographical location of the device to a final geographical location of the device and to store the guided tour as a file onto the memory for later retrieval wherein the system further comprises a transmitter for transmitting the stored file to another device for navigation assistance.
